(19) United States
(12) Patent Application Publication
(10) Pub. No.: US 2015/0143909 A1
(43) Pub. Date: May 28, 2015

(54) APPARATUS FOR NONDESTRUCTIVE CRACK INSPECTION

(71) Applicant: UNIST ACADEMY-INDUSTRY RESEARCH CORPORATION, Ulsan (KR)

(72) Inventors: Franklin Bien, Ulsan (KR); Hyon Gi YOO, Seoul (KR); Zhenyi Liu, Ulsan (KR); Nguyen Ngoc Quang, Ulsan (KR); Seul Ki Rom KIM, Gwangju (KR); Joo Hyeob SONG, Busan (KR)

(21) Appl. No.: 14/555,712

(22) Filed: Nov. 28, 2014

(30) Foreign Application Priority Data
Nov. 28, 2013 (KR) 10-2013-0146241

(51) Int. Cl. G01N 29/14; G01N 29/44

(52) U.S. Cl. CPC G01N 29/14; G01N 29/4445; G01N 2291/044
USPC 73/587

(57) ABSTRACT

According to the present invention, it is possible to determine a defect on a product caused in a press process by applying a predetermined acoustic signal to an object to be inspected and then sensing propagation of the applied signal, and it is possible to improve inspection performance, using an acoustic sensor capable of sensing sounds in an audible band and a high-frequency sensor capable of sensing sounds in an non-audible band.

### CROSS-REFERENCE TO RELATED APPLICATIONS

This application claims the priority of Korean Patent Application No. 10-2013-0146241 filed on Nov. 28, 2013, in the Korean Intellectual Property Office, the disclosure of which is incorporated herein by reference.

### BACKGROUND OF THE INVENTION

1. Field of the Invention

The present invention relates to an apparatus for nondestructive crack inspection, and more particularly, to an apparatus for nondestructive crack inspection that can perform nondestructive inspection, using an audio-band acoustic sensor and a non-audio-band acoustic sensor.

2. Description of the Related Art

In a process of producing predetermined panels using a press machine, there is a need for inspecting the produced panels in real time.

In the related art, workers inspected whether there was a defect on panels or not with naked eyes. However, there are problems of slow inspection and low accuracy.

Further, when there is a problem inside a panel, it is not easily found and seriously influences the stability and efficiency of a finished product.

Accordingly, in a pressing process of producing panels, it is required to find at the early stage whether there is a defect or not such as fine deformation and fine cracks of the produced panels.

### SUMMARY OF THE INVENTION

An aspect of the present invention provides an apparatus for nondestructive crack inspection that can determine a defect of a product caused in a pressing process by applying a predetermined acoustic signal to an object to be inspected and then sensing propagation of the applied signal.

An aspect of the present invention also provides an apparatus for nondestructive crack inspection of which inspection ability is improved by an acoustic sensor capable of sensing sounds in an audible band and a high-frequency sensor capable of sensing sounds in a non-audible band.

An aspect of the present invention also provides an apparatus for nondestructive crack inspection that can prevent defective panels from being put into the following process line by inspecting panels produced in a panel production line.

According to an aspect of the present invention, there is provided an apparatus for nondestructive crack inspection which inspects defects on panels produced in a pressing process. The apparatus includes: a first sensor detachably disposed on a panel and sensing an acoustic signal in an audible band emitted from the panel; a second sensor detachably disposed on panel and sensing acoustic signals in a non-audible band emitted from the panel; an amplifier amplifying and outputting acoustic signals received by the first and second sensors; and a signal processor recognizing whether there is a defect by processing signals outputted from the amplifier.

The apparatus may further include a sound generator applying a sound to the panel.

The audible band that the first sensor senses may range from 16 Hz to 20 kHz.

The non-audible band that the second sensor senses may be 20 kHz or more.

A plurality of the first sensors and second sensors may be provided.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a block diagram illustrating the configuration of an apparatus for nondestructive crack inspection according to an embodiment of the present invention.

### DETAILED DESCRIPTION OF THE PREFERRED EMBODIMENT

Exemplary embodiments of the present invention will now be described in detail with reference to the accompanying drawings.

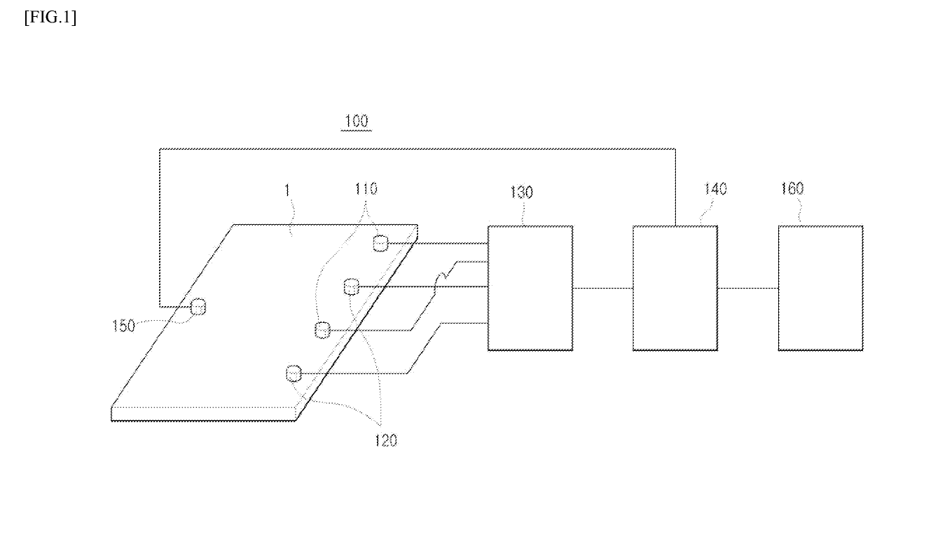

FIG. 1 is a block diagram illustrating the configuration of an apparatus for nondestructive crack inspection according to an embodiment of the present invention.

Referring to FIG. 1, an apparatus 100 for nondestructive crack inspection according to an embodiment of the present invention includes a first sensor 110, a second sensor 120, an amplifier 130, and a signal processor 140.

First, a sound emitted from a panel 1 is briefly explained.

When stress is generated in a predetermined structure, the structure transits from an elastic region to a plastic region and plastic deformation is generated, and when the stress increases, defects such as fine deformation and fine cracks are generated and developed, resulting in failure of the structure. In this process, deformation energy accumulated in the structure is emitted in the form of an elastic wave in each stage from the plastic region and propagated in the structure as an acoustic emission signal that is an elastic wave. The acoustic emission signals that are elastic waves start to be attenuated, depending on the propagation distance, the formation and the type of the medium, so they are sensed at different positions from the origin at different times.

The first sensor 110 senses audio-band acoustic signals emitted from the panel 1, which is an object to be measured, and outputs signals corresponding to the sensed sounds.

The sound signals sensed by the first sensor 110 may be in an audio band having a frequency from 16 Hz to 20 kHz.

The second sensor 120 senses non-audio-band acoustic signals emitted from the panel 1, which is an object to be measured, and outputs signals corresponding to the sensed sounds.

The acoustic signals sensed by the second sensor 120 may be in a higher frequency band than that of the acoustic signals sensed by the first sensor 110. The sound signals sensed by the first sensor 120 maybe in a non-audio band having a frequency over 20 kHz.

The first sensor 110 and the second sensor 120 may be AE (Acoustic Emission) sensors measuring elastic waves (Acoustic Emission; AE).

Although the first sensor 110 and the second sensor 120 are arranged on the panel 1 that is an object to be measured in the figure, if necessary, the first sensor 110 and the second sensor 120 maybe spaced from the panel 1. Further, a plurality of first sensors 110 and second sensors 120 may be disposed, respectively.

Further, a plurality of first sensors 110 and second sensors 120 may be arranged with regular intervals, respectively. Although the first sensors 110 and the second sensors 120 are arranged in a straight line at a side on the panel 1 in the figure, the present invention is not limited and the types and gaps of the arrangement may be changed in various ways. Further, the first sensor 110 and the second sensor 120 may be detachably disposed.

The amplifier 130 is connected with the first sensors 110 and the second sensors 120 through signal lines and amplifies and outputs signals outputted from the first sensors 110 and the second sensors 120, at a predetermined level. The degree of amplifying signals by the amplifier 130 may be changed in accordance with a user's demand.

The signal processor 140 recognizes cracks in the panel 1 that is an object to be measured, by processing signals amplified and outputted from the amplifier 130.

The signal processor 140 recognizes cracks in the panel 1 on the basis of the sensing results of the plurality of the first sensors 110 and the second sensors 120, respectively.

First, the signal processor 140 can locate a defect on the basis of the respective sensing results of the plurality of the first sensors 110 or the second sensors 120.

That is, a predetermined acoustic signal is emitted from a predetermined position where a defect is generated on the panel 1. The emitted acoustic signal can be sensed by the first sensors 1. The distances between the plurality of the first sensors 110 and a defect are relatively different in accordance with the arranged positions, so the first sensors 110 sense an acoustic signal at different times.

The signal processor 140 calculates the distances between an acoustic signal emission position (a defect position) and the first sensors 110, using a distance that sound travels per second, and can find the defect position on the panel 1, using the distances.

Locating a defect on a panel on the basis of output signals from the second sensors 120 is the same as locating a defect on the basis of output signals from the first sensors 110, so the detailed description is not provided.

Further, the signal processor 140 can calculate the size of a defect from the magnitude of an input signal.

When the panel 1 is just placed, any specific sound is not generated from the panel 1. To this end, the apparatus may further include a sound generator 150 that is a part for applying a predetermined sound to the panel 1.

The sound generator 150, a component for applying a predetermined signal to the panel 1, can apply a sound to the panel 1, using a predetermined device (speaker and the like.) selected by a user.

The applied sound is transmitted from an end to another end of the panel 1. A sound can be transmitted without specific distortion, when there is no defect on the panel 1. When there is a defect on the panel 1, a sound passing through the defect maybe distorted, depending on the shape of the defect, and the signal processor 140 receiving the distorted sound through a sensor can recognize the defect on the panel 1, depending on the degree of the distortion.

According to the present invention, it is possible to determine a defect on a product caused in a pressing process by applying a predetermined acoustic signal to an object to be inspected and then sensing propagation of the applied signal, and it is possible to improve inspection performance, using an acoustic sensor capable of sensing sounds in an audible band and a high-frequency sensor capable of sensing sounds in an non-audible band. Further, according to the present invention, it is possible to prevent defective panels from being put into the next process line by inspecting panels produced in a panel production line.

As set forth above, according to exemplary embodiments of the invention, it is possible to determine a defect on a product caused in a press process by applying a predetermined acoustic signal to an object to be inspected and then sensing propagation of the applied signal, and it is possible to improve inspection performance, using an acoustic sensor capable of sensing sounds in an audible band and a high-frequency sensor capable of sensing sounds in an non-audible band.

Further, according to the present invention, it is possible to prevent defective panels from being put into the next process line by inspecting panels produced in a panel production line.

While the present invention has been illustrated and described in connection with the exemplary embodiments, it will be apparent to those skilled in the art that modifications and variations can be made without departing from the spirit and scope of the invention as defined by the appended claims.

What is claimed is:

1. An apparatus for nondestructive crack inspection which inspects defects on panels produced in a pressing process, the apparatus comprising:
a first sensor detachably disposed on a panel and sensing an acoustic signal in an audible band emitted from the panel;
a second sensor detachably disposed on panel and sensing acoustic signals in a non-audible band emitted from the panel;
an amplifier amplifying and outputting acoustic signals received by the first and second sensors; and
a signal processor recognizing whether there is a defect by processing signals outputted from the amplifier.

2. The apparatus of claim 1, further comprising a sound generator applying a sound to the panel.

3. The apparatus of claim 1, wherein the audible band that the first sensor senses ranges from 16 Hz to 20 kHz.

4. The apparatus of claim 1, wherein the non-audible band that the second sensor senses is 20 kHz or more.

5. The apparatus of claim 1, wherein a plurality of the first sensors and second sensors are provided.
